(19) United States
(12) Patent Application Publication
(10) Pub. No.: US 2025/0242440 A1
(43) Pub. Date: Jul. 31, 2025

(54) LASER HYBRID WELDING DEVICE AND METHOD FOR ALUMINUM ALLOY BASED ON IN-SITU SELF-GENERATED REINFORCING PARTICLE

(71) Applicant: Nanjing University of Aeronautics and Astronautics, Nanjing (CN)

(72) Inventors: Xiaohong ZHAN, Nanjing (CN); Yue LI, Nanjing (CN); Jianfeng WANG, Nanjing (CN); Yanqiu ZHAO, Nanjing (CN)

(21) Appl. No.: 19/013,046

(22) Filed: Jan. 8, 2025

(30) Foreign Application Priority Data
Jan. 25, 2024 (CN) 202410107656.7

(51) Int. Cl. B23K 26/211; B23K 26/08; B23K 31/12; B23K 103/10

(52) U.S. Cl. CPC B23K 26/211; B23K 26/0876; B23K 31/125; B23K 2103/10

(57) ABSTRACT

The present disclosure relates to laser hybrid welding device and method for aluminum alloy based on in-situ self-generated reinforcing particle, comprises a fiber laser, a control system, a laser hybrid welding device, a powder feeder and a semiconductor laser. The laser hybrid welding device comprises a gantry crane, a partition, a first guide rail, a second guide rail, a workbench, a first laser welding head and a second laser welding head. The first laser welding head is connected to the semiconductor laser, and the second laser welding head is connected to the fiber laser. The powder feeder can accurately control the conveying speed and proportion of the powder to ensure that the powder particles are located at the to-be-welded position. A semiconductor laser is used for irradiating a to-be-welded position, and a high-temperature condition is generated, so that the particle reinforced phase is promoted to be generated in situ.

The present disclosure claims the priority of the earlier application filed with the China National Intellectual Property Administration on Jan. 25, 2024, with the patent application number 202410107656.7 and the invention title “Laser Hybrid Welding Device and Method for Aluminum Alloy Based on In-situ Self-Generated Reinforcing Particle”. The disclosures of the present disclosure are incorporated by reference herein in their entirety.

### TECHNICAL FIELD

The present disclosure relates to the field of aluminum alloy welding, in particular to a laser hybrid welding device and method for aluminum alloy based on in-situ self-generated reinforcing particle.

### BACKGROUND

Aluminum alloys, known for their low density and high specific strength, are widely used in aerospace, rail transportation, and military equipment industries. Laser welding technology is extensively applied for joining aluminum alloy components due to its advantages of low heat input, high welding speed, and good flexibility. However, the laser welding process can lead to softening of the heat-affected zone and exacerbated segregation of metallic elements in the weld metal, resulting in the service strength of the overall structural components being less than 70% of that of forged materials. Although methods such as optimizing process parameters, regulating trace elements, and introducing external field energy can initially reduce porosity and mitigate segregation, these optimization approaches still have considerable limitations in the production of aluminum alloy welded structural components from the perspective of high quality and efficient production.

During the laser welding process, the addition of reinforcing particles can achieve multi-scale dispersion precipitation of second phases and refine grains, thereby improving the performance of welded parts. Particle addition methods can be classified into externally added particle type and in-situ self-generated type based on the introduction method of reinforcing particles. Unlike the traditional externally added particle method, the in-situ self-generated method forms one or more reinforcing particle phases within the metal matrix through chemical reactions between different elements or compounds under specific conditions, thereby enhancing the hardness, strength, and toughness of the metal. Compared with the externally added particle method, the in-situ self-generated method overcomes interface reaction and wettability issues between the reinforcing phase and the matrix, exhibiting better interface bonding. By introducing in-situ self-generated ceramic particles, multiple nucleation sites are generated during the solidification of the welding molten pool to improve the crystallization process and fundamentally address issues such as microstructural inhomogeneity and segregation caused by non-equilibrium solidification of the molten pool, thereby enhancing the strength and toughness of the welded joints. Therefore, there is an urgent need for an in-situ self-generated ceramic particle reinforcement method for aluminum alloy laser welding.

To address these issues, the present disclosure proposes a laser hybrid welding device and method for aluminum alloy based on in-situ self-generated reinforcing particle. This device and method enable efficient and high-quality welding of aluminum alloys, providing more reliable aluminum alloy welded structural components for industries such as aerospace and high-speed train manufacturing.

### SUMMARY

Aiming at the defects in the prior art, the present disclosure provides a laser hybrid welding device and method for aluminum alloy based on in-situ self-generated reinforcing particle. The device comprises a fiber laser, a control system, a laser hybrid welding device, a powder feeder and a semiconductor laser. The laser hybrid welding device comprises a gantry crane, a partition, a first guide rail, a second guide rail, a workbench, a first laser welding head and a second laser welding head. Powder particles with different components are fed into the micro molten pool by accurately controlling the conveying speed and proportion of the powder. Under the high-temperature action of the first laser welding head, the powder particles undergo a chemical reaction and self-generated reinforcing particles in situ. The reinforcing particles play a role in refining grains and improving strength and wear resistance. Meanwhile, the second laser welding head is used for welding the aluminum alloy filled with the particle part, the reinforcing particles are distributed in the welding seam, and the strength and toughness of the welding seam are remarkably improved. By using the device and the method, efficient and high-quality welding of the aluminum alloy can be achieved.

To achieve the above objective, the present disclosure adopts the following technical solutions:
A laser hybrid welding device for aluminum alloy based on an in-situ self-generated reinforcing particle, comprising a fiber laser, a control system, a laser hybrid welding device, a powder feeder and a semiconductor laser;
the control system is connected to the fiber laser, the laser hybrid welding device, the powder feeder and the semiconductor laser, and the control system is used for controlling operation and welding parameter selection of the fiber laser, the laser hybrid welding device, the powder feeder and the semiconductor laser;
the laser hybrid welding device comprises a gantry crane, a partition, a first guide rail, a second guide rail, a workbench, a first laser welding head and a second laser welding head; the first guide rail and the second guide rail are connected via a sliding block, and the workbench is arranged to move in two directions; the first laser welding head is connected to the semiconductor laser, and in-situ generation of reinforcing particles is achieved on the basis of laser thermal conduction welding; and the second laser welding head is connected to the fiber laser, and aluminum alloy connection is achieved on the basis of laser deep penetration welding;
the first laser welding head comprises two powder feeding ports, and the powder feeder is connected to each of the powder feeding ports of the first laser welding head, and the powder feeder is used for conveying powder particles and protective gas into the first laser welding head; and the control system is used for controlling a powder discharging amount of the powder particles; and
both the first laser welding head and the second laser welding head are provided with a real-time monitoring system, and the real-time monitoring system is arranged to monitor and record welding process in real time.

Further, both the first laser welding head and the second laser welding head adopt a galvanometer system, and the galvanometer system is used for controlling a movement trajectory of a laser beam.

Further, the first guide rail and the second guide rail are connected via the sliding block, so that the workbench is arranged to move in both a X direction and a Y direction.

Further, the powder feeder is used for conveying powder particles of different components, and under an action of the first laser welding head, in-situ generation of reinforcing particles is achieved on the basis of a chemical reaction of the powder particles; the second laser welding head is used for welding an aluminum alloy filled with reinforcing particles; and the first laser welding head and the second laser welding head is arranged to operate synchronously or independently.

Further, the powder particles comprise Ti powder and B4C powder, and under a thermal action of a semiconductor laser output by the semiconductor laser, the following reactions occur:

$$3 Ti + {B}_{4} C = 2 {TiB}_{2} + TiC$$

$$5 Ti + {B}_{4} C = 4 TiB + TiC$$

through these reactions, TiB₂, TiB and TiC reinforcing particles are formed on a surface of the aluminum alloy for the subsequent fiber laser welding of aluminum alloys based on in-situ self-generated reinforcing particles.

A laser hybrid welding method for aluminum alloy based on the in-situ self-generated reinforcing particle, wherein the method comprises the following steps:
Step one, performing surface treatment on the aluminum alloy to remove oil stains and oxide films on the aluminum alloy, making the surface of the aluminum alloy clean and tidy, and performing spheroidization and drying treatment on the powder particles;
Step two, placing the treated aluminum alloy on a welding fixture, adjusting a position of the aluminum alloy by using the control system, and coating water glass at a to-be-welded position on the aluminum alloy;
Step three, starting a laser hybrid welding device, wherein the powder feeder conveys powder particles and protective gas into the first laser welding head; and adjusting a position of the first laser welding head to ensure that the output powder particles are located at a to-be-welded position on the aluminum alloy, and irradiating the powder particles by using a high-energy laser beam, so that the powder particles form reinforcing particles in situ;
Step four, regulating a laser output power, a welding speed and an oscillation amplitude of the second laser welding head through the control system, and performing optical fiber laser welding on a position where the reinforcing particles are formed, so that the reinforcing particles are uniformly distributed in a welding seam; and during the fiber laser welding process, the control system monitors a quality of the welding seam and adjusts the laser power and the welding speed of the second laser welding head in real time based on feedback; and
Step five, conducting quality inspection on the welded aluminum alloy.

The advantages and positive effects of the present disclosure are as follows:

The present disclosure provides a laser hybrid welding device and method for aluminum alloy based on in-situ self-generated reinforcing particle. The core idea of this device and method is to introduce ceramic particles during the laser welding process, generate reinforcing particles through in-situ self-generation, and distribute them in the welding seam, thereby achieving multi-scale precipitation of the second phase and refining the grain structure. Compared with the preparation methods of composites with externally added particles, the in-situ self-generation approach overcomes the issue of interface reaction between the reinforcing phase and the matrix, and the ceramic particles spontaneously nucleate and grow within the original metal matrix, improving the poor interface wettability. At the same time, the stirring effect of the galvanometer laser promotes uniform distribution of the particles, reduces welding defects, and enhances the uniformity of the microstructure. By using this device and method, the porosity and segregation degree during the welding process can be effectively reduced, the crystallization process can be improved, and the strength and toughness of the welded joint can be enhanced.

### BRIEF DESCRIPTION OF THE DRAWINGS

FIG. 1 is a diagram of a laser hybrid welding device for aluminum alloy based on in-situ self-generated reinforcing particle.

FIG. 2 is a diagram of a device for preparing in-situ self-generated reinforcing particles.

FIG. 3 is a diagram of a movable welding platform device.

FIG. 4 is a schematic diagram of laser powder-fed welding for aluminum alloy based on in-situ self-generated reinforcing particles.

1—fiber laser, 2—control system, 4—powder feeder, 5—semiconductor laser, 6—real-time monitoring system, 7—galvanometer system;
3—laser hybrid welding device: 31—gantry crane, 32—partition, 33—first guide rail, 34—second guide rail, 35—workbench, 36—powder feeding port, 37—first laser welding head, 38—second laser welding head, 39—sliding block.

### DETAILED DESCRIPTION OF THE EMBODIMENTS

For the convenience of a person skilled in the art, the present disclosure will be further described in detail below with reference to the accompanying drawings and embodiments. It is understood that the specific embodiments described herein are merely for the purpose of explaining the present disclosure and are not intended to limit the scope thereof. Additionally, it should be noted that for ease of description, only the parts relevant to the present disclosure are shown in the accompanying drawings, rather than the entire structure.

The present disclosure will be further illustrated through a specific embodiment below.

### EMBODIMENT

This embodiment is based on the context of high-precision connections for rocket tanks, and involves laser welding of 4 mm-thick 2219 aluminum alloy.

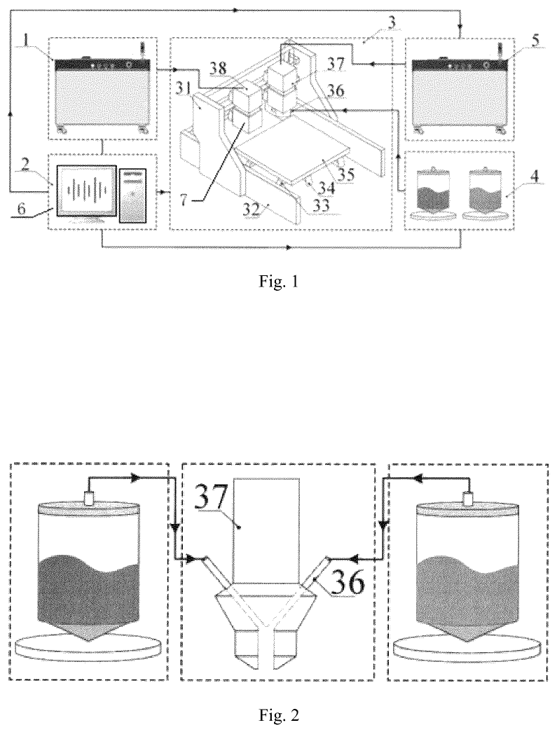

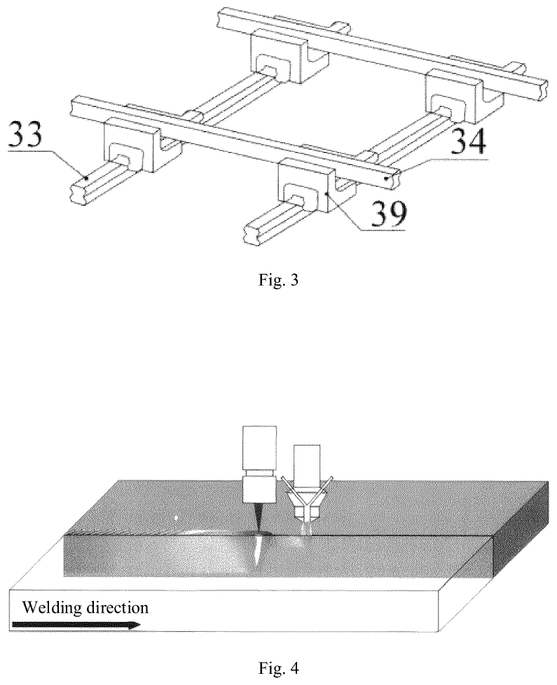

As shown in FIG. 1, the present disclosure discloses a laser hybrid welding device for aluminum alloy based on an in-situ self-generated reinforcing particle, comprising a fiber laser 1, a control system 2, a laser hybrid welding device 3, a powder feeder 4 and a semiconductor laser 5.

The control system 2 is connected to the fiber laser 1, the laser hybrid welding device 3, the powder feeder 4 and the semiconductor laser 5, and the control system 2 is used for controlling operation of each system and welding parameter selection.

The laser hybrid welding device 3 comprises a gantry crane 31, a partition 32, a first guide rail 33, a second guide rail 34, a workbench 35, a first laser welding head 37 and a second laser welding head 38; the first guide rail 33 and the second guide rail 34 are connected via a sliding block 39, so that the workbench 35 can move in two directions; the first laser welding head 37 is connected to the semiconductor laser 5, and in-situ generation of reinforcing particles is achieved on the basis of laser thermal conduction welding; and the second laser welding head 38 is connected to the fiber laser 1, and aluminum alloy connection is achieved on the basis of laser deep penetration welding.

The first laser welding head 37 comprises two powder feeding ports 36, the powder feeder 4 is connected to each of the powder feeding ports 36 of the first laser welding head 37, and the powder feeder 4 is used for conveying powder particles and protective gas into the first laser welding head 37. The control system 2 can accurately control a powder discharging amount of the powder particles. Both the first laser welding head 37 and the second laser welding head 38 are provided with a real-time monitoring system 6, and the real-time monitoring system 6 is arranged to monitor and record welding process in real time, ensuring the traceability and reliability of the welding quality.

Both the first laser welding head 37 and the second laser welding head 38 adopt a high-speed galvanometer system 7, and the galvanometer system 7 enables rapid scanning and precise control of the laser spot's movement trajectory, allowing in-situ generated reinforcing particles to be uniformly distributed, thereby enhancing welding speed and accuracy.

The sliding connection between the first guide rail 33 and the second guide rail 34 allows the workbench 35 to move in both the X and Y directions, accommodating the positioning of workpieces with different welding requirements.

The powder feeder 36 delivers powder particles of different compositions. Under the action of the first laser welding head 37, in-situ generation of reinforcing particles is achieved based on the chemical reaction of the powder. The second laser welding head 38 welds aluminum alloy, distributing its particles within the welding seam to enhance the strength and toughness of the welding seam. The first laser welding head 37 and the second laser welding head 38 can operate synchronously or independently.

A method based on the in-situ self-generation of reinforcing particle, the powder particles can be selected from Ti and B4C powders, which undergo the following reaction under the thermal effect of a laser:

$$3 Ti + B 4 C = 2 {TiB}_{2} + TiC$$

$$5 Ti + {B}_{4} C = 4 TiB + TiC$$

Forming reinforcing particles such as TiB₂, TiB, and TIC, and refining the microstructure of the welding seam.

A laser powder filling welding method for aluminum alloy using in-situ self-generated reinforcing particles based on a laser hybrid welding device for aluminum alloy based on in-situ self-generated reinforcing particle, comprising the following steps:
Step one, performing surface treatment on the aluminum alloy to remove oil stains and oxide films, making the surface of the aluminum alloy clean and tidy, and performing spheroidization and drying treatment on the Ti and B₄C powder particles;
Step two, placing the treated 2219 aluminum alloy on a welding fixture, and adjusting the position by using the control system;
Step three, starting a laser hybrid welding device, conveying particles and protective gas into the first laser welding head by the powder feeder, wherein the laser power is 1000 W, so that the particles generate reinforcing particles in situ;
Step four, controlling the laser power of the second laser welding head to be 4500 W through the control system, wherein the welding speed is 1.2 m/min, so that the reinforcing particles are uniformly distributed in the welding seam, and welding of the aluminum alloy is realized; and
Step five, conducting quality inspection on the welded workpiece to ensure the welding quality and strength requirements.

It is evident that the aforementioned embodiments of the present disclosure are merely examples provided for the purpose of clearly illustrating the present disclosure, and are not intended to limit the embodiments of the present disclosure. For those skilled in the art, based on the ideas of the present disclosure, changes in specific embodiments and application scopes will be made. The content of this specification should not be construed as limiting the present disclosure. Any modifications, equivalent substitutions, and improvements made within the spirit and principles of the present disclosure should be included within the scope of protection of the claims of the present disclosure.

What is claimed is:

1. A laser hybrid welding device for aluminum alloy based on an in-situ self-generated reinforcing particle, comprising a fiber laser (1), a control system (2), a laser hybrid welding device (3), a powder feeder (4) and a semiconductor laser (5);
the control system (2) is connected to the fiber laser (1), the laser hybrid welding device (3), the powder feeder (4) and the semiconductor laser (5), and the control system (2) is used for controlling operation and welding parameter selection of the fiber laser (1), the laser hybrid welding device (3), the powder feeder (4) and the semiconductor laser (5);
the laser hybrid welding device (3) comprises a gantry crane (31), a partition (32), a first guide rail (33), a second guide rail (34), a workbench (35), a first laser welding head (37) and a second laser welding head (38); the first guide rail (33) and the second guide rail (34) are connected via a sliding block (39), and the workbench (35) is arranged to move in two directions; the first laser welding head (37) is connected to the semiconductor laser (5), and in-situ generation of reinforcing particles is achieved on the basis of laser thermal conduction welding; and the second laser welding head (38) is connected to the fiber laser (1), and aluminum alloy connection is achieved on the basis of laser deep penetration welding;
the first laser welding head (37) comprises two powder feeding ports (36), and the powder feeder (4) is connected to each of the powder feeding ports (36) of the first laser welding head (37), and the powder feeder (4) is used for conveying powder particles and protective gas into the first laser welding head (37); and the control system (2) is used for controlling a powder discharging amount of the powder particles; and
both the first laser welding head (37) and the second laser welding head (38) are provided with a real-time monitoring system (6), and the real-time monitoring system (6) is arranged to monitor and record welding process in real time.

2. The laser hybrid welding device for aluminum alloy based on the in-situ self-generated reinforcing particle according to claim 1, wherein both the first laser welding head (37) and the second laser welding head (38) adopt a galvanometer system (7), and the galvanometer system (7) is used for controlling a movement trajectory of a laser beam.

3. The laser hybrid welding device for aluminum alloy based on the in-situ self-generated reinforcing particle according to claim 1, wherein the first guide rail (33) and the second guide rail (34) are connected via the sliding block (39), so that the workbench (35) is arranged to move in both a X direction and a Y direction.

4. The laser hybrid welding device for aluminum alloy based on the in-situ self-generated reinforcing particle according to claim 1, wherein the powder feeder (4) is used for conveying powder particles of different components, and under an action of the first laser welding head (37), in-situ generation of reinforcing particles is achieved on the basis of a chemical reaction of the powder particles; the second laser welding head (38) is used for welding an aluminum alloy filled with reinforcing particles; and the first laser welding head (37) and the second laser welding head (38) is arranged to operate synchronously or independently.

5. The laser hybrid welding device for aluminum alloy based on the in-situ self-generated reinforcing particle according to claim 4, wherein the powder particles comprise Ti powder and B4C powder, and under a thermal action of a semiconductor laser output by the semiconductor laser (5), the following reactions occur:
$$3 Ti + B 4 C = 2 {TiB}_{2} + TiC$$
$$5 Ti + B 4 C = 4 TiB + TiC$$
through these reactions, TiB₂, TiB and TiC reinforcing particles are formed on a surface of the aluminum alloy for the subsequent fiber laser welding of aluminum alloys based on in-situ self-generated reinforcing particles.

6. A laser hybrid welding method for aluminum alloy based on the in-situ self-generated reinforcing particle according to claim 1, wherein the method comprises the following steps:
Step one, performing surface treatment on the aluminum alloy to remove oil stains and oxide films on the aluminum alloy, making the surface of the aluminum alloy clean and tidy, and performing spheroidization and drying treatment on the powder particles;
Step two, placing the treated aluminum alloy on a welding fixture, adjusting a position of the aluminum alloy by using the control system (2), and coating water glass at a to-be-welded position on the aluminum alloy;
Step three, starting a laser hybrid welding device, wherein the powder feeder (4) conveys powder particles and protective gas into the first laser welding head (37); and adjusting a position of the first laser welding head (37) to ensure that the output powder particles are located at a to-be-welded position on the aluminum alloy, and irradiating the powder particles by using a high-energy laser beam, so that the powder particles form reinforcing particles in situ;
Step four, regulating a laser output power, a welding speed and an oscillation amplitude of the second laser welding head (38) through the control system (2), and performing optical fiber laser welding on a position where the reinforcing particles are formed, so that the reinforcing particles are uniformly distributed in a welding seam; and during the fiber laser welding process, the control system (2) monitors a quality of the welding seam and adjusts the laser power and the welding speed of the second laser welding head (38) in real time based on feedback; and
Step five, conducting quality inspection on the welded aluminum alloy.
